(19) United States
(12) Patent Application Publication
(10) Pub. No.: US 2010/0172217 A1
(43) Pub. Date: Jul. 8, 2010

(54) System of Methods and Apparati for Handling and Modifying Information Energy and Matter by Formative Resonance

(76) Inventor: Ernst von Bezold, Richmond Hill (CA)

Correspondence Address: Ernst von Bezold, RR2, 1020 Rutherford Rad, Maple, Ontario, L6A 1S2, omitted

(21) Appl. No.: 12/350,960

(22) Filed: Jan. 8, 2009

(51) Int. Cl. G01V 1/04

(52) U.S. Cl. 367/190

(57) ABSTRACT

This invention relates to an improvement in systems, methods and apparati for handling and processing information, energy and matter by making use of potentials of new technologies, science and industrial art, principally in cymatics, quantum field theory and psychoenergetic science. It comprises a system of methods and apparati for handling information, energy and material using multimodal cymatic (standing wave patterning, whether stationary or moving) generation, and manipulation, principally of material and energy in vorticoid including concatenated and grouped vorticoid forms, to concentrate, cleanse, separate, transform, produce etc., materials and energy, including without limitation the production of clean water and manufactures materials, the production of net usable energy by effects such as Schauberger and vacuum potential-related, the collection, processing and communication of information by nonlocal quantum coherence (entrainment) of dynamic systems, initially cymatic, viz., vorticoid, the similar transport of lower-dimensionality material patterns, i.e., materials, also to facilitate transport of living organisms, and the tuning of higher-dimensional energy forms, i.e., formative fields, for applications such as healing; a means of fine-tune controlling such systems directly by means of psychoenergetic operator interaction and indirectly by means of conditioned space technologies and vibratory enhancing technologies such as “scalar” treated materials and systems; and by other means described as “gauge-symmetry”-level raising, here, e.g., Bearden; and their combination; and a means of facilitating learning to generate Tiller-effect spacial conditioning (higher gauge symmetry) enhancement using motivated feedback in utilising these systems with spacial conditioning technology assist.

### BACKGROUND OF THE INVENTION

This invention relates to an improvement in methods of handling and processing information, energy and matter. It was developed initially to make use of potentials of new technologies, science and industrial art to problems of non-chemical purification, with little or no chemicals added beyond water, of pre-combustion inputs and post-combustion outputs in thermoelectric power generation. The invention extends their application to new, nonobvious and useful systems of methods and apparati for the production, transformation and distribution of matter, energy and information.

### PRIOR ART

With respect to the system of methods and apparati which is the subject of this application, and embodiments therefor, the work of the following, their predecessors and experimentally, clinically or epistemologically near neighbours, form the principal precedent contributions drawn on by this writer: Viktor Schauberger (Austria), Theodor Schwenk (Germany), Hans Jenny (Switzerland), Lawrence Edwards (England), Shafica Karagulla (Canada, United States), Marcel Vogel (United States), Fritz-Albert Popp (Germany), Thomas E. Bearden (United States), Ernst von Bezold (Canada) and William A. Tiller (Canada, United States). The following discussion outlines those contributions applicable to this work as understood by this writer and builds on them to show their relationship to novel, nonobvious and useful aspects of the invention here disclosed.

Viktor Schauberger was an Austrian forester and technologist whose works are now also widely available in English (1). He observed that when a current in a flowing stream winds centripetally and then centrifugally with an opposite sense of spin, at the turning point of the change of direction of rotation, oxygenation occurs and from this place also there is an energetic flow transverse to the direction of the current, into the stream banks, stimulating the growth of vegetation in those areas. Working with this and similar observations Schauberger was able to invent and frequently to patent ‘naturalesque’ technologies for diverse applications including trans mountain lumber transport and for transportation; for water purification, energy production, which he identified as environmentally healthier and therefore sustainable in comparison with still-prevalent environmentally destructive mechanistic technologies.

The centripetal-centrifugal spiral effects he reported (see figure) and made use of (‘Schauberger effect’) have been applied here in guiding the development of the invention, in light also of observation in the human being's energy field by numerous independent, highly sensitive and skilled observers, of major chakras (see for example S. Karagulla), whirling energetic flexible cones extending well beyond the physical body, situated at and through major glandular centres and aligned in pairs tip-to-tip pointing in opposite directions from the front and back of the body (e.g., B. Brennan and others) set along a central energy channel (called Sushumna in the orient) which runs vertically coincident with the human spine.

Theodor Schwenk's work on water as a spiraling and projective-geometrically characterisable cosmic sense organ demonstrated, by wheat germination trials using shaken water, the existence and rhythms of cosmic, i.e., extraterrestrial, atmospherically significant Zeitgeber environmental rhythms, and therefore the importance of taking into account not only the use of vortices but also the significance of macroenvironmental rhythms in cleaning and enlivening water organisms to function harmoniously with the syntropic potential of the biospheric macroenvironment.

Hans Jenny was a physician living in Dornach, Switzerland who developed the field of Cymatics, creating and filming steady and moving three-dimensional standing waves generally produced with fluid agitated to a standing wave by sound through a loudspeaker base, based on Ernst Chladni's acoustically produced two-dimensional standing wave figures and on an appreciation of the contribution of vibration to the creation of form. Hans Jenny patented a device for making speech visible [ca. 1968; reference].

In a Chladni figure such as that formed by sprinkled fine sand vibrating on the back of a bowed horizontally held violin, the distribution of nodes and antinodes in the particular mode of vibration of the substrate medium, i.e., the violin back, at the frequencies at which it is being excited, may be displayed by the redistribution of the scattered sand in a pattern corresponding to the position of nodal and or to antinodal points and boundaries, evidently dependent primarily on the size and density of the sand particles. This acoustically mediated resonance has been researched by Jenny, Armin Husemann, Sherry Edwards and others as one of a number of formative principles in the human body. A formative faculty (classically, the facultas formatrix) was cited by Johannes Kepler to explain snow crystal form variation (the body of formative forces of the Earth); was researched in embryology by Erich Blechschmidt; and considered more broadly, has been studied as a phenomenon of internal communication demonstrable optically and functionally e.g., electrically, in all living organisms, by Fritz-Albert Popp and coworkers.

These examples of energetic formative processes in whole systems, i.e., in bodies of connected parts, demonstrate a formative paradigm which is applied and extended with multimodal energy flows or activity sources, e.g., electro-magneto-gravitic-(/levitatory)-]optic-acoustic and scalar, as well as psychoenergetic, for application in the invention.

Lawrence Edwards, an English mathematics teacher and biology researcher, showed that tree buds breathe, or fluctuate rhythmically, in winter around an ideal middle form whose projective geometric path curve is related to the golden mean. His vortex spiral calculation methods and examples are cited here as prior art for the production of vortices and their energetic as well as material products which will enliven nature functionally, in the sense Schauberger described and demonstrated, rather than degrading nature.

Dr. Shafica Karagulla left the Montreal Neurological Institute to do research on higher sense perception, eventually founding with Viola Neal the Higher Sense Perception Foundation in Los Angeles. Karagulla's clinical reporting of the correlation between chakra structure and activity on the one hand, and physiological health status such as patient endocrinology on the other (1965), provide along with the work of V. V. Hunt (UCLA) and other investigators such as R. Steiner a reliable modern base of published observation of some typical human psychoenergetic anatomy and its corresponding function.. This enables those less skilled in the art of such observation to make better use of transitory or fragmentary experimental data and to apply with greater confidence, along with those not making such observations, the findings of others as a source of design modeling information.

Marcel Vogel, a solid state chemist was instrumental in developing the first magnetic memory disk drive coating for IBM. Vogel published work (1973) demonstrating that psychoenergetic telekinetic phenomena become reproducible with sufficient experimenter self-training of the mind which is the instrument of manifesting such psychoenergetic phenomena. Taken together with the contribution of Tiller, Vogel's work exemplifies a shift to scientific knowledge and ordinary technical application of human capacities which have become a part of the state of the art in healing and are applied in the invention for process control enhancement of which water purification, energy production and telecommunication are three examples.

Fritz-Albert Popp founded the International Institute of Biophysics (Neuss, Germany, a collaborative research undertaking of dozens of scientists globally. His paradigm shifting discoveries have shown that the activity of a quantitatively small amount of energy, as light, directs and maintains the organisation of the body's biochemical activity, and that essentially all measured bioenergetic functions of organisms, e.g., skin electrical resistivity as measured in humans at hundreds of points on the hands, demonstrate an internal coherence predictive and therefore indicative of health. Normative self-validating measurement of coherence (cf. L. Edwards) in the functioning of cymatic structures is therefore incorporated as a monitoring and feedback control criterion of a preferred embodiment of the invention. Popp patent:

Thomas E. Bearden, a career research scientist (US Army, retired), wrote the book on Energy from the Vacuum (2002). His paper on Giant Negentropy from the Common Dipole provides a physical science foundation for the Schauberger effect which in its higher order gauge symmetry application appears consistent with W. A. Tiller's description of a second, more psychoenergetically malleable level of the physical world access to which depends on an engineerable coupling function. Bearden's presentation of a corrected and extended physics, taken together with technology which demonstrates it (Patrick et al., U.S. Pat. No. 6,362,718, MEG) provides with Schauberger's work the basis in the present invention justifying a the strategic objective of a water cleaning design for power plants which can be upgraded and modified functionally over time to increase net energy production process efficiencies so as to enable combustibles to be reduced and eventually phased out. Bearden's scientific-historical apparatus also provides a point of comparison with Tiller for quantitative modeling of conditioned space effects incorporated as a functional energy control option within the invention.

Ernst von Bezold published on the BDnow! Agricultural email list (2001), a description which then was archived by colorado.edu, of a class of technologies, i.e., using shapes combined with rhythmitized materials, based in part on L. Edwards' work on shapes applied to the functional renewal, by applying a thin coating of rhythmitized copper ointment (a therapeutic preparation manufactured by, e.g., Wala or Weleda in Europe, and Merkhur Laboratories in Canada, whose detailed experimental scientific basis is referenced by R. Hauschka), of cow horns used in bio-dynamic agriculture, e.g., in making manure or powdered quartz preparations. The principle of cohering shape and material, intensified by rhythmical treatment of the material (treatment such as may also be found in N. Tesla's purple plates, evidently in the Austrian Johannes Grander's water treatment technology, or in more recent “scalar”-resonant liquid treatment vessels and jewelry) has a parallel in the technology of the great pyramid at Giza and an extension in the biogeometry of A. Kareem as and as presented by R. Gilbert, et al. As described earlier in relation to Edwards' work, this principle is applied here with respect to optimised vortex shaping (cf. Edwards) and material, in this case water, formed and controlled cymatically, with psychoenergetic system control enhancement, and eventually, generation.

William A. Tiller, former department chair and professor emeritus of material science and engineering at Stanford University, wrote Psychoenergetic Science as a simplification and compilation of three previous related volumes documenting 30 years of paradigm-shifting experimental science on the demonstrable, potential, and instrumentally engineerable enhancement of, the integral functional contribution of consciousness to the matter-energy equilibrium of the object-oriented physical science paradigm presently being transformed by the more interactive understanding of reality shown in quantum physics being applied in such diverse fields such as cryptography, quantum computing and psychoneuroimmunologic therapies. Tiller's empirical work on space conditioning for process modulation, together with his work and that of Vogel on experimenter training for replicability (cf. Charles Tart, “state-specific science”) applies and extends the implications of the Indian preceptor Patanjali (ca, 8^{th} century) in a unique and distinctly instrumentally modern, scientifically verified and technologically accessible form. The invention applies both the trained-operator effect and the instrument-mediated spacial conditioning effects to control and enhance multimodal cymatic processing and to and anticipate its transformative progression in part as an operator-initiated and controlled activity with corresponding strategic extension of options of scope and scale of application.

### REFERENCE NOTES

1. 1. Drawings, and descriptions in English, are available from and, respectively for, the work of V. Schauberger e.g., translated and edited by Callum Coates, Ecotechnology v. 1-4. Gateway, Dublin, Ireland, 1997-2000.
2. Hans Jenny: Cymatics. Basel, Switzerland.
3. Shafica Karagulla: Breakthrough to Creativity. DeVorss, Santa Monica Calif., ca, 1965
4. Marcel Vogel: Reproducible long distance communication with plants detailed in Proceedings of the Second International Psychotronics Conference, Prague, 1973.
5. Interview for Canadian Broadcasting Corporation ‘Ideas’ series “Physics and Beyond”, 1973.
6. Fritz-Albert Popp: Director International Institute of Biophysics, Neuss, Germany. For bibliography see www.lifescientists.de
7. Edwards, Lawrence: The Vortex of Life nature's patterns in space and time. Floris, Edinburgh, 1993. ISBN 0-86315-148-5
8. Bearden, T. E.: “Giant Negentropy from the Common Dipole,” cited from Journal of New Energy, 5(1), Summer 2000, p. 11-23. Offprint by the Planetary Association for Clean Energy, Inc., Ottawa Canada; ISBN 0-919969-11-9 [2001].
9. Energy From the Vacuum concepts and principles. Xxviii, 952 p. Cheniere Press, Santa Barbara Calif., 2002.
10. Patrick; Stephen L. Bearden; Thomas E., Hayes; James C., Moore; Kenneth D., Kenny; James L. Motionless electromagnetic generator. U.S. Pat. No. 6,362,718. Mar. 26, 2002
11. Tiller, W. A.: Psychoenergetic science: a second Copernican-scale revolution. Pavior Publishing, Walnut Creek, Calif. c. 2007. ISBN 978-1-4243-3863-4 www.tiller.org

### BRIEF SUMMARY OF THE INVENTION

Essentially, and without limitation of this description to its application in an illustrative preferred embodiment, a cymatic (3- or higher-dimensional Chladni figure-generating) resonant vibrational process is used to induce a rotating standing wave figure in a fluid, such as water, air, plasma, or a slurry including solids, producing a centripetal vortex or vortex of vortices which passing inward through the focus of the tip unwinds from its tip in the same or by induction in an opposite rotation, or meets another incoming vortex tip or tips, at the juncture comprising the tip(s) focus producing differentiable active and potential energetic outputs, and from the focus a likewise differentiable outflow of materials in directions primarily other than that of the axis of tip focus, such as transverse, of least resistance as shaped and sorted within transporting flows of standing waves e.g., whose node-antinode frequencies, amplitudes and spacial configurations are appropriately resonant with selected materials and material-energetic configurations. The forming and modulation of the form may be by external or internal, direct or interferometrically induced, multimodal electro-magneto-gravitic-opto-acoustic and scalar potential drivers controlled by feedback of functional parameters of the manipulated material flow and feedback of the driving energy inputs and their energetic transforms, and having regard to macroenvironmental conditional-probability fluctuations, e.g., in turbulent flow, and, in early embodiments, being fine tuned—later, consequent on operator learning based on feedback with the system as an instrument of learning, increasingly being generated—by operator interaction directly (Vogel), or indirectly using conditioned space effect technology (Tiller) amplification-modulation or other higher gauge broken symmetry operations (Bearden), to bias threshold condition probabilities favourably in respect of intended states of the system.

### BRIEF DESCRIPTION OF THE DRAWINGS

Annotated List of FIGS. 1. to 4(a)-(f)

FIG. 1. Background of the invention and cross-reference for FIG. 3. which illustrates a feature of a preferable embodiment of the invention:

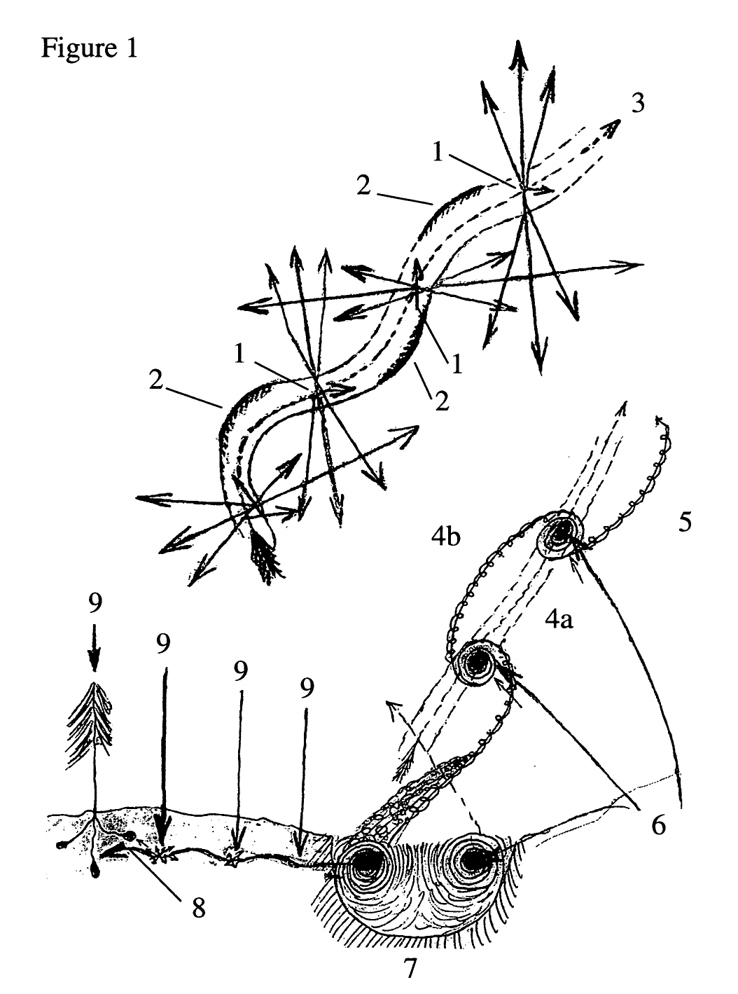

An example from river current flow, “The Inner Picture of the Dynamics of Current Flow”, showing inward spiraling with reversal of spiral direction at the point, i.e., in the region, of start of outward spiraling—and indicating transverse-vectored radiant propagation of energy, as well as in this context reactive enhancement, i.e., oxygenation—is from Schauberger, 1941, as reproduced in Coates, Vol. 1, 1997.

FIGS. 2 and 3. Illustrations of features of preferable embodiments of the invention:

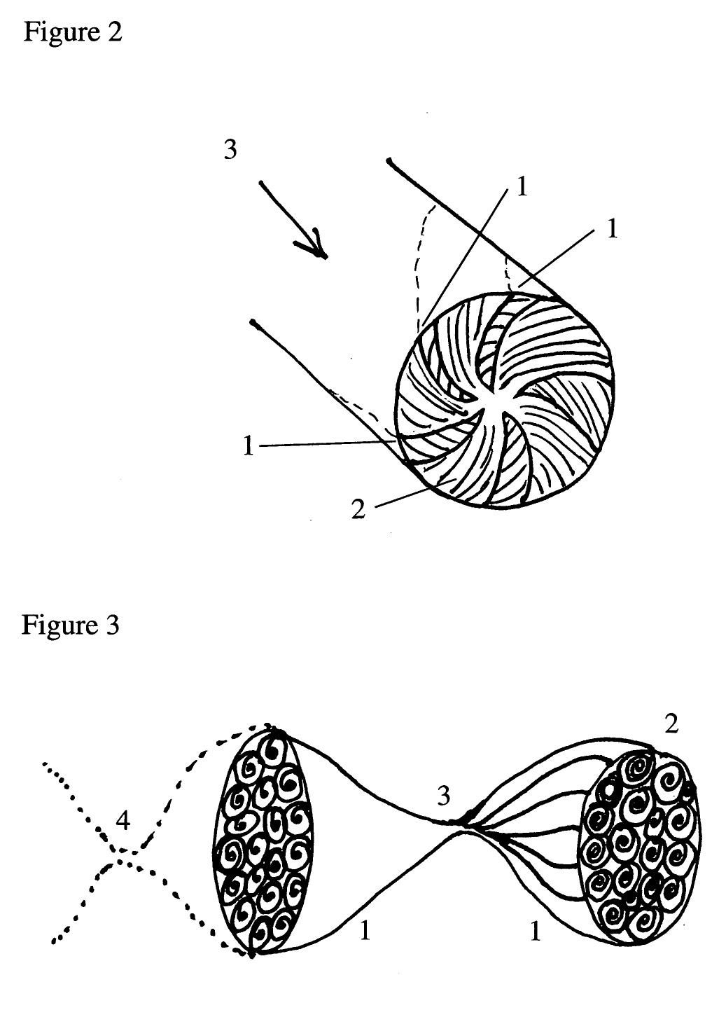

FIG. 2. A sketch of a sample cross-section functionally spiraling pathway, i.e. here as spirally-fluted piping, whether formed structurally, or through the formed and formative injection of materials such as water into and as a part of the pathway, or in part or in whole energetic-dynamically, or by some combination or permutation of these.

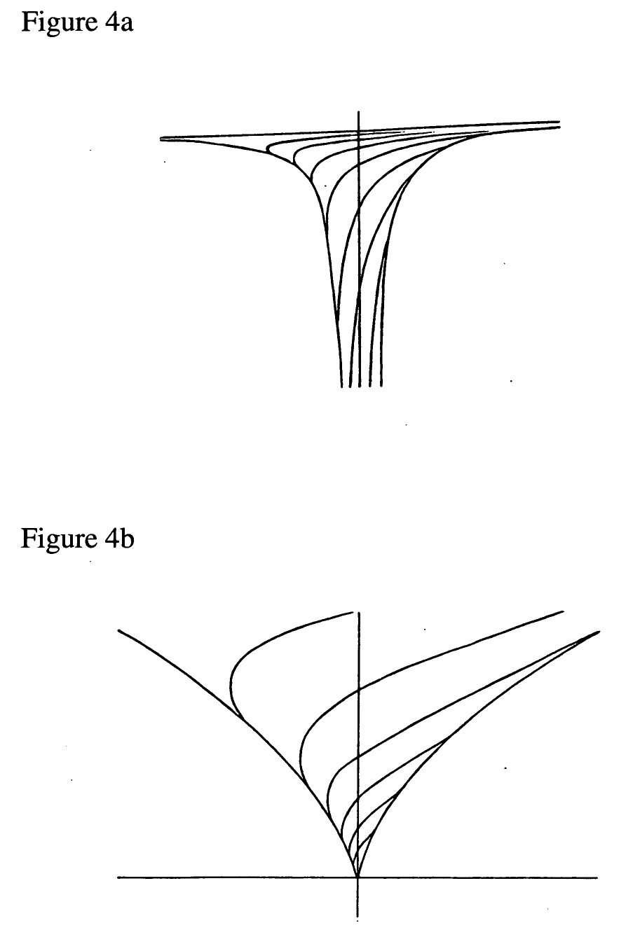

FIG. 3. A sketch of a sample complex vortex of vortices, modeled on the inventor's observation as well as on descriptions, of naturally-occurring and developed or “built” complex vortex structures which may be characterised as dynamically stable n-dimensional “standing wave” structures. The example is of a collinear pair of complex vortices shown in oblique cross-section; to the left in the figure is appended a dotted-line indicator of a contiguous, expansion-contraction vortex figure such as may be found in FIG. 1 with a second point of maximal vortex centripetal concentration, as may also be seen in FIG. 4(f). This vortex meeting, or transition, point is a focal region of energy concentration and release which as a focal point of modulation (depending also on vortex spin directions) can be used to amplify the modulating signal's effect in the centrifugal or expansive phase or, respectively depending on vortex spin directions, to modulate energy released along another vector from the focal region; for a naturalesque example; see FIG. 1.

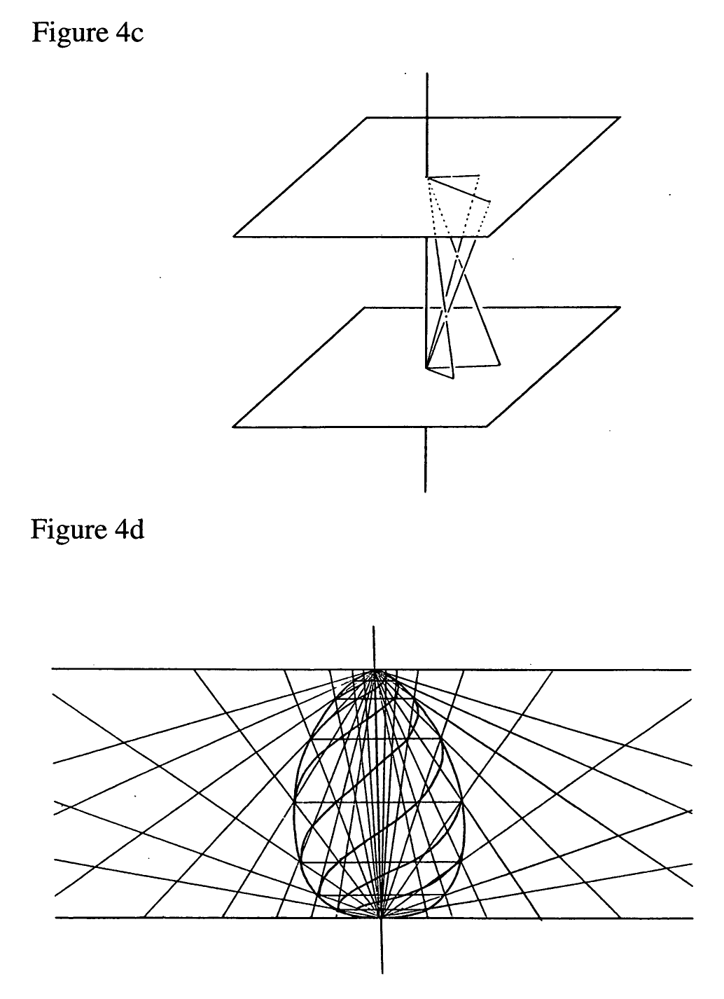

FIG. 4 note: Such sets of vortices can be concatenated in various geometries—linearly, in rings, nested, etc.—as information energy and materials handling and transformation structures, e.g., in the processing of water of whatever phase, and gases or other materials, of energy, and of information, associated with combustion, of coal, etc; with other manufacture of energy and of material substance in preferred composition, form, state, and the production of purposed information-rich structures or forms and structures or forms for processing information; with the sensing or other collection, processing, communication of information and associated energetic and material entities, e.g., as information carriers, viz., modulating and as modulators, locally and nonlocally, for example using functionally entrained (i.e., resonantly tuned) nonlocally paired single or doubled (for energetic balance) sets of more or less triple vortices, e.g., three-dimensionally depending on intended function, which are monitored and modulated at the origin (see 4(e) below), e.g., using one or more members of the class of modulators listed above, especially operator- or user-specifiable modulators, to enable transfer of informational, energetic, material pattern momentum between the nonlocally paired vortex sets, in order to facilitate convenient transfer of process-related patterning for the effective replication of data, of energy states, or transfer under competent operation conditions of low-dimensional-number patterns that act as localizing carriers for higher-dimensionally-resonant homeostatic structural fields and their associated states, i.e., principally in living organisms. The same principle can be applied reflexively to enhance holotropic pattern stability of organisms with respect to an operator-programmable template field; e.g., as two examples among many, for conservation and improvement of biotic function and its patterned energetic basis using an algorithmically-controlled amplifier to enhance food stability and therefore conservation or to support healing based on modulation of a resonantly shaped and directed energy flow using a reflexively applied template which is functionally operator-enhanced.

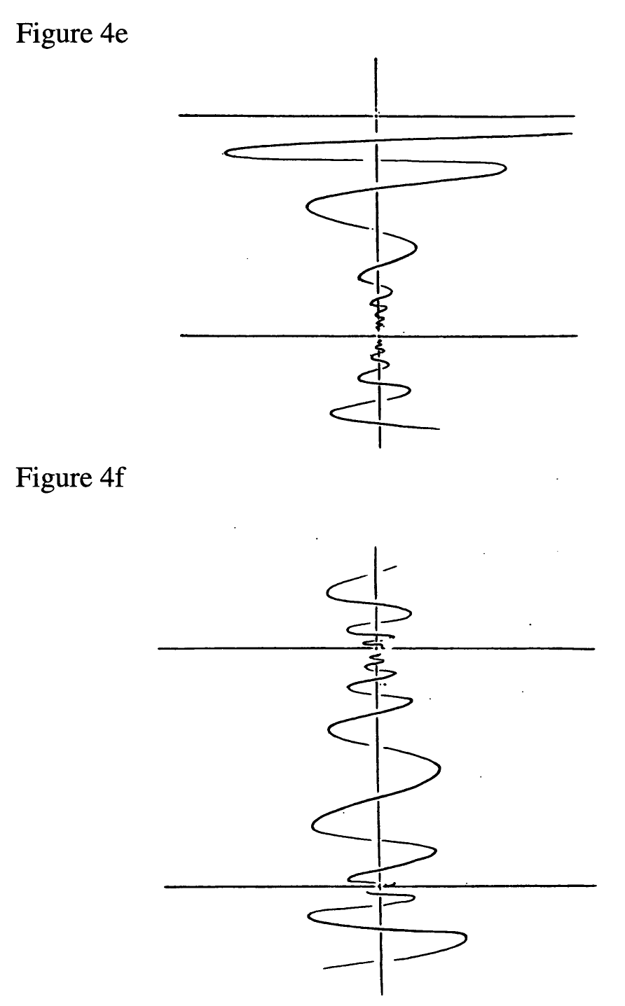

As cited above, a mathematical apparatus for calculating projective-geometrically visualisable vortex and related path curves, including but not limited to a sample computer program, and sample illustrations of the families of curves employed here, which it is proposed are a functional correspondent class of the shapes observed and then designed and used by V. Schauberger, may be found in Lawrence Edwards' work, inter alia: The Vortex of Life, 1993. See also articles in Mathematical-Physical Correspondence; and, The Field of Form, 1982. FIG. 4 illustrates examples of some applicable projective-geometric curves and their calculation from Edwards (1993); of classes of curves to be applied and based on the mathematical descriptions of their classes, to be used in examples, indicated descriptively in the foregoing (i.e., in the accompanying) text, of preferred embodiments of the invention.

### DETAILED DESCRIPTION OF THE INVENTION

The present invention now will be described more fully with reference to the general inventive concept, and to illustrate embodiments of the invention. As this invention may be embodied in many different forms, its scope should not be construed as limited to the exemplary embodiments set forth; rather, the examples are provided to indicate a scope of potential preferred embodiments to those skilled in the art.

The present invention of a system of methods to handle information, energy and materials and to modify their properties relates to the modification by manipulation iteratively (including but not limited to, in particular, recursively; the term “iteratively” is so used throughout), simultaneously and prospectively or retrospectively, of the potential and manifest energetic, temporal and spacial coordinate, motional and orientational, coherence and informational or entropic status, dimensionality including but not limited to metric (dimensional curvature), combination or dissociation, of materials in amounts and states ranging from particle to compound and bulk mass, including but not limited to plasma, gas, solid and liquid states singly, intermixed or combined, making use of one or a coordinated combination (including but not limited to, as the case may be, ordered combination, i.e., permutation; “combination” is so used as an inclusive term, throughout) of more than one structure and system of vibration and resonance of material or energetic shape, including but not limited to environmental Zeitgebers or related factors or their artificial analogues, in a feedback or resonance-controlled manner permitting dynamically active, i.e., reflexively, iteratively and synchronically varying differentiation, integration, transformation including but not limited to metamorphosis or conversion from one state to another, of informational, energetic and associated material states, systems, forms and entities.

The invention consists of a unimodal or multimodal integrated system of methods as outlined here to handle information, energy and material and modify their properties, including but not limited to local and nonlocal interaction, patterning and coherence.

An example of a class of embodiments is as it relates to communication of information, energy and material, particularly between the holographic sub-quantum and quantum-level entrainment and cross-modulation of asymptotically and hyperbolically n-dimensionally pattern-matched, e.g., including but not limited to in particular functionally synchronous nonlocal, systems of information, energy and material.

Another example of a class of embodiments is as it relates to holotropically “self”-similar precursorial re-equilibration of organisms and entities, including but not limited to in particular their energetic (viz. their persisting or durable sub- and quantum-resonant) template or formative pattern in a range of applications from medicine to physical device and structures maintenance, to re-establish a proximal functional and structural wholeness at a higher level of holistic functional coherence, in particular also therefore to re-tune them optimally with and to a resonant pattern of macro-environmentally current syntropy with its accessible dimensional and nondimensional substates. “Vis medicatrix naturae per facultatem formatrix”: i.e., re-tune organism to their archetypal (basic, healthy) formative patterns in harmony with the macrobiosphere, “The healing life of nature [accessed] through the formative faculty”.

An example of a class of embodiments preferable for their obviously immediately beneficial and pertinent application relates principally to the energies and material substance associated with solids, with liquid and gaseous fluids and solids associated with them; to plasma, and associated quantum-energetic (viz., respectively, subquantum-energetic, i.e., including but not limited to, in particular, [“quantum”-]nonlocally entrained energetic-potential such as so-called zero-point) states.

A specific application in this class of embodiment is its use for the pre-, real-time ongoing, and post-treatment of fluids, in particular, water and gases including but not limited to related particulates, associated with combustion, in the processing, particularly the cleaning, of pre-, combusting and post-combustion gases, in particular, respectively, gaseous/ified combustants, products and proximal energy, materials and energetic patterns associated with combustion of e.g., hydrocarbons such as coal; by the use singly and in combinations; continuously, and discontinuously, through design-resonant, or forced pulsation inducing turbulence, pulsation, cavitation; of physical-structurally, or energetically, e.g., acoustically; magnetically; etc.; functionally spiraling, e.g., spirally-fluted piping, pathways which may be used to induce or facilitate; optionally with 2, 3 or more dimensional Chladni-figure, i.e., cymatic, dynamically shifting resonance/feedback-controlled electro-magneto-gravitic-levitatory-opto-acoustic-temporal-spacial standing-wave patterns, including but not limited to scalar Whittaker fine structure signaling particularly for thermal behaviour control of materials, and application of Grander and Tiller field-effect systems; and also, optionally with a class of directly operator-driven phenomena, e.g., Keely-effect, Vogel-method or “Hutchison-effect” induction;

to condense or rarefy and drive spacially, i.e., to segregate, mix, react, shape, etc., said fluids, viz. gases and their constituent and included substances including but not limited to precipitates, elements and compounds to be formed or dissociated, fractionated out, otherwise modified, and to assist in the production of energy; especially, in particular, where certain forms are approached or striven for or referenced, such as the mean as well as ideal value cycloid space curve families described by Lawrence Edwards in the life of nature, materials in these forms being evidently energizing resonant transducers of water quality renewal and related effects; and forms such as the bio-geometrically-analysed designs—e.g., concavities in structures, such as, e.g. a gradual half-degree indentation of each of the outer upper surfaces of the Great Pyramid at Giza used to induce “horizontal negative green”, and other, cone-pendulum-response states as presented and described by A. Kareem, R. Gilbert and others—which may be favourable or conducive to the improvement of informational content, energy and material, e.g., i.e., in this case of quality of water and gases and their forms and behaviours, especially combustion-associated gases and water in whatever phase, and of their environment, and of related cleansing, reactive or structural-energetic-chemical including but not limited to biochemical stabilizing activity in this setting as well as in other settings such as biochemical cleansing, stabilisation, renewal of living organisms, their environment and precedents including but not limited to inputs and succedents including but not limited to outputs.

Modulation preferentially may be varied in feedback, resonantly simultaneous with, or preceding (e.g., within entrainment parameter values range) synchrony with, environmental Zeitgebers and their measures, e.g., using rhythmitized shapes (rhythmitised shaping functions in classes such as that of the Great pyramid, cow horns and other natural structures as resonators, described as mathematical function classes by L. Edwards), with respect to the patterns shown by astronomical ephemerides, and the mathematical descriptions of, in particular, planes and other shapes or figures formed among massive bodies during their transits, by astronomically related variations in the values of the tensor Tau sub jk and associated described functions including but not limited to those identified by G. Unger of Dornach, Switzerland, and by associated indicators; to optimise negentropic as well as entropic functions severally and in combination.

A specific class of instances of this kind of embodiment would utilise rotating multimodal fields and resonant “radiative” and “field” effects, whether by gross energetic induction as described or by resonant rhythmitised shaping or by indirect Tiller-type or directly operator-programmed tuning or combinations to induce essentially, preferably by means without moving parts,

the enlivening of energy and of material, i.e., of water;

pre-cleaning and conditioning of gases; including but not limited to, for both water and combustion-related gases, electrical or other energetic charging or programming, e.g., magnetic induction of appropriate coherent spin and precession of particles and other structures, e.g., hydrogen proton precession;

cymatic vortical motion including but not limited to, based on the work of Viktor Schauberger, Theodor Schwenk and others, centripetal as well as, as may be useful or conducive in application, centrifugal, and alternating centripetal/centrifugal, with “braiding” of flows to facilitate blending—respectively separation of succedent materials and states—of spiraling gases and water; leading to improved mixing, modification and separation of materials, and improved control of energy production, improved cleansing and production of associated materials in usable higher quality lower cost form than might otherwise be the case;

modification of gasification, precipitation, and endo/exothermic processes by Whittaker fine structure signaling, by Grander spacial and magnetic induction, et. seq., especially for real-time process- and flow-control stabilisation;

modification of the foregoing and of other processes, states and conditions through operator-controlled intent and concentration of energies, indirectly by programmable-unit Tiller “field effect” action, viz. gauge-symmetry level modulation, as well as directly, including but not limited to Keely-technology and Vogel-methodology effects.

An example of a design which preferably embodies elements of the foregoing in an application to facilitate production of clean combustion by-products of coal and of other combustibles or pre-combustible feedstocks and their combustion processing materials and systems, the materials being principally water and air, with an optimal net production of environmentally life-enhancing (i.e., also therefore, minimally life-degrading) quality and quantity of energy, material and information especially bioinformation, is as follows:

Iteratively, and by resonance including but not limited to pre-emptive or pattern-anticipatory entrainment-leveraging e.g., phase-lock, signaling,

1. Form water and gas flows architecturally, i.e., physical-structurally using the patented and unpatented built as well as the designed examples from among: R. Steiner; especially, V. Schauberger with numerous illustrations of examples in patents and other literature to be cited; T. Schwenk; J. Grander; and for informational, energetic and materials modulating effects using shaped rhythmitised materials, E. von Bezold (2001); and, by means of a “complex” vortex, i.e., a set of complex vortices each comprised of multiple vortices arranged in groups as dynamically stable standing-wave “cells”, the focal point of each of which may centre on and be contiguous with the focal point of a corresponding collinear vortex whose mouth is pointed in the opposite direction to the first, or with the focal points of a number of vortices dynamically balanced energetically and in space, all with one another.

2. Also shape the streams, e.g., for a first approximation as exemplified in the foregoing paragraph, vibrationally by tuned coherent energetic induction and modulation magnetically/diamagnetically, opto-acoustically-thermally using dynamic Chladni-figure standing-wave vortices, i.e., after the cymatics of H. Jenny et. al.—also approached by the flow forms of Wilkes, articulated by A. Husemann and others, also alluded to mathematically by G. Adams, by P. Forchheimer, later by T. Schwenk (1954) who cites I Prigogine in the context of sensitive control-response; discussed mathematically by R. Abram and concurrently and subsequently especially in the work of L. Edwards—in the classes of shapes expressed mathematically by L. Edwards (1993) who provides calculation methods, computer software and diagrammatic illustrations: oscillating, varying, within and around syntropic, life optima “antenna” shapes, e.g., mean as well as ideal shapes, tuned over time to work with principal macro-environmental (Zeitgeber) rhythms; and transformed (e.g., by rotation and by translation in flow, e.g., induced acoustically or by optically-tunnelled electromagnetic radiation, e.g., amplitude-, frequency- and waveform-specific light, such as squeezed light or other coherent as well as incoherent light) metrically and physico-chemically, pulsated, and otherwise modulated to induce enhanced laminar flow, controlled turbulence, and cavitation-reformative collapse cycles, including but not limited to cycles that are rhythmically- i.e. resonantly-enhanced; and further to modulate the sensitive, cf. T. Schwenk, non-equilibrium, cf. I. Prigogine, self-organising activity.

3. Concurrently, modify the processes locally and globally, in part and in whole, using as appropriate the means described in 1. and 2., and other available signalling energizing systems as modulators for the above control systems and as net additional inputs and, as appropriate, use energetic outputs to be fed back into the system as controlling modulators; including but not limited to, as examples, electrostatic dispersion; complementary electrical charging; electrolysis; magnetic, endo/exothermal, other emf or energetic treatment including but not limited to macroenvironmental signals, unamplified and amplified; to, e.g., increase, maintain or reduce solubility; flow formation, as described above, to enliven fluids; centripetal cyclones, compression vortex mixing and transformation of inputs, e.g., vortical compression wave precipitation threshold modification; space state, time state and information coherence system behaviour state programming, e.g., via proximity field conditioning, e.g., Tesla purple plate technology or other “scalar treated” programmed resonators, characterisable for example in quartz by a Cartesian matrix spaced throughout the material of silicon atoms each containing a proton with a doubled Lissajous figure; Tiller-effect units; Grander units; Whittaker structure modulation to improve e.g., output cleansing, output precipitation conditions as well as to optimise thermal production efficiency exothermically internally and endothermically at specified system functional boundaries to eliminate net environmental negative impact and, as with the whole system, optimise positive impact; further to the description in 2., use of sound and acoustically-tuned EMF, e.g., as heterodyned fields, and other means to induce mass hyperacceleration and velocity effects, and other methods of catalysis, e.g., to improve reaction chemistry, hydroxyl radical and hydrogen chemistry optimization, etc.; further applications integrated synergically with above processes, of acoustic, especially pulsating, and EMR (electromagnetic radiation) and other radiative effects other than magnetic; e.g., for improved control of combination-dissociation processes by sound, acoustico-magnetic, infrared, UV, etc., within transient standing-wave cells whose opto- and magneto-acoustics are, for example, like those demonstrated optically by a cyclone, a tornado or an optical fibre, i.e., distinctly self-contained or transmissive in a parametrically-specific manner.

Specific terms employed for illustration should be read in a generic and descriptive sense only and not for purposes of limitation. The scope of the invention is further set forth in the following claims.

1. A system of methods and apparati for handling information, energy and material using multimodal cymatic (standing wave patterning, whether stationary or moving) generation, and manipulation, principally of material and energy in vorticoid including concatenated and grouped vorticoid forms, to concentrate, cleanse, separate, transform, produce etc., materials and energy, including without limitation the production of clean water and manufactures materials, the production of net usable energy by effects such as Schauberger and vacuum potential-related, the collection, processing and communication of information by nonlocal quantum coherence (entrainment) of dynamic systems, initially cymatic, viz., vorticoid, the similar transport of lower-dimensionality material patterns, i.e., materials, also to facilitate transport of living organisms, and the tuning of higher-dimensional energy forms, i.e., formative fields, for applications such as healing.

2. A means of fine-tune controlling such systems directly by means of psychoenergetic operator interaction and indirectly by means of conditioned space technologies and vibratory enhancing technologies such as “scalar” treated materials and systems; and by other means described as “gauge-symmetry”-level raising, here, e.g., Bearden; and their combination.

3. Means of facilitating learning to generate Tiller-effect spacial conditioning (higher gauge symmetry) enhancement using motivated feedback in utilising these systems with spacial conditioning technology assist.

4. Further, based on the foregoing, all related dependent claims which may properly be construed from the foregoing.
